(19) United States
(12) Patent Application Publication
(10) Pub. No.: US 2005/0028925 A1
(43) Pub. Date: Feb. 10, 2005

(54) Method for making a prepreg

(76) Inventors: Karim B. Fernandes, Alta Loma, CA (US); Jeffrey T. Gotro, Trabuco Canyon, CA (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 10/655,789

(22) Filed: Sep. 4, 2003

Related U.S. Application Data
(60) Provisional application No. 60/408,394, filed on Sep. 4, 2002.
(60) Provisional application No. 60/408,421, filed on Sep. 4, 2002.

(51) Int. Cl. B32B 31/00

(52) U.S. Cl. 156/269; 156/250

(57) ABSTRACT

A continuous method to make a prepreg with improved thermal conductivity and electrical properties for use in multilayer printed circuit boards.

This application claims the benefit of U.S. provisional application No. 60/408,394 (Attorney Docket No. 100765.0002PRO) filed on Sep. 4, 2002 and titled “Method for Making a Prepreg and Using It in Printed Circuit Boards with Heavy Copper Internal Planes”, and the benefit of U.S. provisional application No. 60/408,421 (Attorney Docket No. 100765.0003PRO) filed on Sep. 4, 2002 and titled “Method for Making Enhanced Thermal Conductivity Resin Film and Prepreg”, each of which is incorporated herein by reference in its entirety.

### FIELD OF THE INVENTION

The present invention relates to methods for making a partially cured, solventless, reinforced thermosetting polymer film (called a prepreg), and more particularly relates to methods for making partially cured, solventless, reinforced thermosetting polymer film (prepreg) having improved thermal conductivity. These thermally enhanced reinforced polymer films are used improve the thermal performance of multilayer printed circuit boards. Improving the thermal performance of the printed circuit board is an important design parameter in the packaging of power supply products and other electronic components that generate a large amount of heat during standard operation.

### BACKGROUND OF THE INVENTION

The current state-of-the-art for manufacturing partially cured, reinforced thermosetting polymer prepregs involves coating a reinforcement (woven glass cloth, non-woven glass cloth, non-woven organic fiber papers) with a resin solution consisting of thermosetting resins and high vapor pressure solvents.

Traditional prepregs for printed circuit boards are manufactured by coating woven glass cloth with a solvent-based resin system. The resin systems are typically epoxy resins or high-performance epoxy resins. Other resins such as cyanate esters, phenolics, novolacs, and polyimides can also be used. During the impregnation process, the woven glass cloth must be immersed into the liquid epoxy to thoroughly coat the cloth allowing the resin to penetrate into the glass cloth bundles. The next step is to evaporate the solvent from the moving web. After the solvent is removed, additional heat is applied to the moving web to cause a chemical reaction to take place. Chemical bonds form (crosslinking reactions) causing the molecular weight and the viscosity to increase. The temperature and time at temperature are carefully controlled to enable only a partial curing to occur. Not all of the reactive groups are allowed to react in the treating process. The partial curing is termed B-staging. Unreacted resin is termed A-staged, partially cured prepreg is termed B-staged, and fully cured resins are termed C-staged.

As an example in FIG. 1, a roll of woven fiberglass 1 is loaded onto the front end of the treater. The fiberglass is carried over a series of rollers to a dip pan 2 containing a solvent-based resin solution. The fiberglass cloth is saturated by the resin solution in the dip pan 2 making sure the fiberglass is completely coated. The resin content is controlled by counter-rotating metering rolls 3. The coated fiberglass web enters a controlled temperature oven. In the first part of the oven 4 solvent is carefully removed. In the second zone of the oven 5, the remaining solvents (typically high boiling solvents) are removed. The web then enters two additional heated zones 6, 7 to partially react (B-stage) the resin. The coated fiberglass emerges from the oven as a tack-free, B-staged prepreg. The prepreg can be rolled onto a wind-up station 8 or run through a sheet cutter 9 to cut the panels into the appropriate sheets 10.

Solvent-based impregnation methods can cause several detrimental problems during the treating operation. Solvent evaporation leads to voids in the prepreg. If these voids are not eliminated during the lamination of the circuit board, reliability failures (high potential dielectric breakdown failures, or hipot fails) could occur leading to circuit board performance degradation. Solvent evaporation during the treating operation causes the ratio of the resin to solvent (% solids) to change, potentially leading to difficulties controlling the amount of resin applied to the reinforcement. The solvent vapors are collected, incinerated, and scrubbed prior to emission into the atmosphere. This is costly to maintain the incineration and scrubbing equipment and also requires expensive environmental permitting.

Typical epoxy-based prepregs and laminates have approximately 0.5-1.0 W/m°K thermal conductivities. When used in typical multilayer printed circuit boards, these materials have limited ability to dissipate heat or provide thermal spreading.

Multilayer circuit board fabrication involves building a structure containing two or more layers of patterned conductive sheets (typically copper) insulated by a polymeric dielectric. The dielectric is typically a high performance fiberglass reinforced epoxy resin. The first step involves the circuitization of copper clad laminate cores using well-established lithographic techniques (print and etch). The laminate cores are fully cured (C-staged) fiber reinforced resin covered with a copper foil. The thickness of the core and thickness of the copper can be tailored for the particular type of circuit board.

Multilayer boards are made by placing B-staged prepreg (partially cured epoxy resin impregnated into a woven fiberglass fabric) between the circuitized cores and laminating the stack-up using heat and pressure. The B-staged prepreg serves two purposes; first, as a source of resin to flow into and between the circuit traces and secondly, as an adhesive to bond the circuitized cores together. Multilayer boards can have 4 layers to greater than 40 layers of circuitry. The process is similar regardless of the number of layers.

Methods to manufacture a continuous fiber reinforced prepreg using a solventless thermosetting resin will be presented. U.S. Pat. No. 5,633,042 teaches a process for continuously manufacturing a prepreg for use as an electrically insulating material. The method comprises the coating of one surface of a fibrous sheet reinforcing substrate with a solventless, molten thermosetting resin matrix using a die coater. The coated fibrous sheet is passed thru an infrared heater oven to soften the resin to aid in the saturation of the fibrous sheet. Additionally, the matrix resin is forced into the fibrous sheet by pressurizing the matrix resin and fibers by means of a plurality of temperature controlled rolls to smooth out and force the resin into the reinforcing resin. The smoothing rolls occur between the coating step and the semi-curing step. The coated fibrous sheet reinforcing material is heated via non-contact heaters to semi-harden (B-stage) the thermosetting matrix resin. Additionally, the process cuts the semi-hardened material into discrete sheets at the end of the process.

U.S. Pat. No. 5,387,301 teaches a method of manufacturing a prepreg that comprises coating a release liner with a low viscosity matrix resin, supplying reinforcing fibers between the lower coated release liner and an uncoated upper release liner, and impregnating the reinforcing fibers with the matrix resin by heating and pressing the release papers into the reinforcing sheets. The top release liner is removed in a next step. In a subsequent step, a room temperature curing hardener is coated onto the top surface of the reinforcing fibers coated with the matrix resin. In another embodiment, both the first and second release liners are coated with the matrix resin and the reinforcing fibers are introduced between the two coated release liners. Heat and pressure are used to force the thermosetting resin matrix into the reinforcing fibers. The matrix resin impregnated reinforcing fibers are not semi-cured or B-staged.

In both U.S. Pat. No. 5,633,042 and U.S. Pat. No. 5,387,301 the matrix resin is a thermosetting resin, specifically epoxy-based formulations. These are cured with standard curing agents such as dicyandiamide and imidazoles. In both these patents, no mention is made to the use of insulating ceramic fillers to increase the thermal conductivity of the matrix resin and the resulting composite material.

U.S. Pat. No. 4,571,279 teaches a method for producing a continuous metal clad reinforced laminate for use in electronic applications. The method covers impregnation a plurality of fibrous reinforcements (specifically a cellulosic substrate) with a liquid, solventless matrix resin. The matrix resin is a polyester resin. The method also encompasses collecting multiple moving webs of fiber reinforcements, impregnating them with the matrix resin, collecting into a unitary member, placing a covering layer on the top and bottom of the moving sheet and fully curing without using pressure. The covering layers in the preferred embodiment are copper foils. The result is a fully-cured copper clad laminate ready for subsequent processing into a circuit board core.

### SUMMARY OF THE INVENTION

The current invention describes a continuous method to make a prepreg with improved thermal conductivity and electrical properties for use in multilayer printed circuit boards. In one application, the prepreg can be laminated to a heavy aluminum base plate to make Insulated Metal Substrate (IMS) type printed circuit boards.

In another application, the thermally enhanced prepreg can be used to build a multilayer circuit board. In this example, single or multiple sheets of prepreg are sandwiched between circuitized cores to form the stack-up. A subsequent lamination process uses high temperature and pressure to cure the prepreg and consolidate the stack-up into a rigid, fully-cured multilayer circuit board. The prepregs and subsequent laminates made using the current invention have significantly improved thermal conductivities.

In another example, the prepreg can be made according to the present invention with copper sheets on each side of the prepreg and subsequently processed in a lamination press to form a fully cured core. The fully cured core can be circuitized using standard print and etch methods. A multilayer printed circuit board can be fabricated by sandwiching circuitized cores with additional sheets of prepreg and lamination at high temperature and pressure to form a fully cured multilayer printed circuit board. The prepregs and subsequent laminates made using the current invention have significantly improved thermal conductivities, allowing fabrication of a printed circuit board with improved heat spreading and thermal conductivities.

Process Overview

The present invention relates to methods for making a partially cured, solventless, reinforced thermosetting polymer film (called a prepreg), and more particularly relates to methods for making partially cured, solventless, reinforced thermosetting polymer films having improved thermal conductivity.

In the preferred embodiment, a solventless hot-melt polymer film is coated onto a moving release liner by means of a slot die extrusion head. The hot-melt polymer is heated in a temperature controlled reservoir and pumped through a temperature controlled transfer line to the heated slot die manifold. A precise thickness is extruded onto the moving release liner.

Woven glass cloth is required to provide the prepreg with the necessary mechanical integrity during the handling and layup process used to form multilayer circuit boards. A very thin glass cloth style (typically 104 and 106) is used to minimize the amount of woven glass in the final prepreg. As seen in Table 1, fiberglass cloth has a low thermal conductivity and a high dielectric constant, subsequently, the amount of glass cloth in the prepreg should be minimized to obtain the optimum thermal and electrical properties.

Additionally, the glass cloth must be thoroughly impregnated with the hot-melt resin prior during the prepreg manufacturing process. Typical style 104 woven glass cloth has 51 filaments per bundle in the fill yarns and 102 filaments per bundle in the warp yarns. Style 104 woven fiberglass has a thickness of 1.2 mils (0.0012″) and style 106 woven fiberglass has a thickness of 1.5 mils (0.0015″) and are the preferred glass fabrics for thermally enhanced prepregs. To ensure high reliability during hipot testing and to prevent electrochemical migration during lifetime of the product, complete impregnation of the fiber bundles is critical. To accomplish this objective, the woven glass cloth is thoroughly coated using a roll coating device. The roll coater moves resin into the woven glass bundles from one side, thus pushing entrapped air out of the fiber bundles and out of the space between the filaments, leading to a void free resin coated glass cloth. This method of coating the continuously moving woven reinforcement is a significant improvement over the methods taught in U.S. Pat. No. 5,633,042 and 5,387,301. Secondly, the impregnation of the moving reinforcement is a separate and carefully controlled process. The resin content can be precisely controlled by adjusting the coating roll speed, the amount of resin placed on the coating roll, and the line speed of the moving reinforcement across the roll coating head. The independent roll coating method to impregnate the moving reinforcement is a significant improvement to the prior art.

The resin coated glass cloth is then placed in contact with the top surface of the polymer thin film from the slot die extrusion head using a set of temperature-controlled and polished rolls. A second set of calendaring rolls is used to precisely control of the final thickness. After the coated glass cloth and hot-melt resin are consolidated into a unitary film, the sandwich is partially cured (B-staged) in a continuous oven. Infrared (IR) heaters are used to impart a programmed temperature profile on the moving web to initiate the crosslinking reaction. Controlled crosslinking is required to control the flow of the polymer in the lamination process used to make a multilayer circuit board.

After the B-staging is completed, the hot web is cooled using a set of chill rolls. The temperature is controlled in the chill rolls using cold water circulating through the interior of the rolls. A top release liner is placed on the top surface of the glass cloth polymer film structure to protect the prepreg during handling and storage. The edges are trimmed using an on-line cutter. The final length dimension is obtained using an in-line cutter.

Materials Overview

Thermally enhanced dielectrics (including prepreg and non-supported resins) were developed having thermal conductivities >3 W/m°K. In the preferred embodiment, the coating resin consists of a solventless formulation of epoxy resins, curing agents, accelerators, and fillers. The epoxy resins provide the required physical properties and can easily be melt-processed. Suitable epoxy resins were chosen to achieve a glass transition temperature (Tg) of greater than 160° C. Typical epoxy resins include diglycidyl ether of bis-phenol A, diglycidyl ether of bis-phenol F, epoxy cresol novolac, epoxy novolacs, and brominated epoxy resins (such as. Additionally, thermosetting resins such as cyanate esters, and polyimides can also be utilized to develop resins with even higher Tg's.

The curing agent helps crosslink and forms the desired network structure and achieves the desired glass transition temperature (Tg). Suitable curing agents include dicyandiamide, imidazoles (various types of substituted imidazoles), and Lewis acid curing agents such as boron trifluoride-amine compounds. The use of solvents is avoided for both ease of handling, environmental, and worker safety concerns. Additionally, the resin system is flame retardant allowing a UL flammability rating of 94-V0. Resins used in multilayer printed circuit boards must achieve the UL flammability rating.

The thermal conductivity and dielectric constant of the epoxy fiberglass laminates that are currently used to make multilayer circuit boards are shown in Table 1. Epoxy fiberglass laminate has a thermal conductivity of approximately 0.3 W/m°K.

TABLE 1
Material Properties

| | Thermal Conductivity | Dielectric |
|---|---|---|
| Material | (W/m° K.) | Constant (Dk) |
| Fiberglass cloth | 0.8 | 6.2 |
| Epoxy resin | 0.2 | 3.5 |
| Epoxy fiberglass laminate | 0.3 | 3.8-4.8 |
| PTFE (Teflon) | 0.2 | 2.1 |
| Phenolic resin | 0.2 | 3.5 |
| Copper | 394 | Conductive |
| Aluminum | 217 | Conductive |

In order to improve the thermal conductivity of the resin system and maintain the electrical properties (low dielectric constant and electrical insulation), ceramic fillers are employed. In Table 2, typical properties for several insulating ceramic fillers are given. Boron Nitride (BN) has a high thermal conductivity and low dielectric constant. For fast electrical signal speed, circuit board designers require materials with low dielectric constant. The use of BN is the preferred embodiment for the present invention. Alternatively, Aluminum Oxide and Aluminum Nitride may be used to achieve enhanced thermal conductivities, but the dielectric constant of the resultant polymer/ceramic will be higher compared with a composite made using BN.

TABLE 2
Typical Material Properties for Ceramic Fillers

| | Thermal Conductivity | Dielectric |
|---|---|---|
| Conductive Filler | (W/m° K.) | Constant (Dk) |
| Boron Nitride (BN) | 60-160 | 4 |
| Aluminum Oxide (Al2O3) | 30 | 9 |
| Aluminum Nitride (AlN) | 50-170 | 9 |

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1. Solvent impregnation method to make prepregs (prior art)

FIG. 2 shows a schematic of the process of the current invention

FIG. 3 shows the details of the solventless prepreg line

FIG. 4 is a cross section of the typical prepreg configuration at the end of the line.

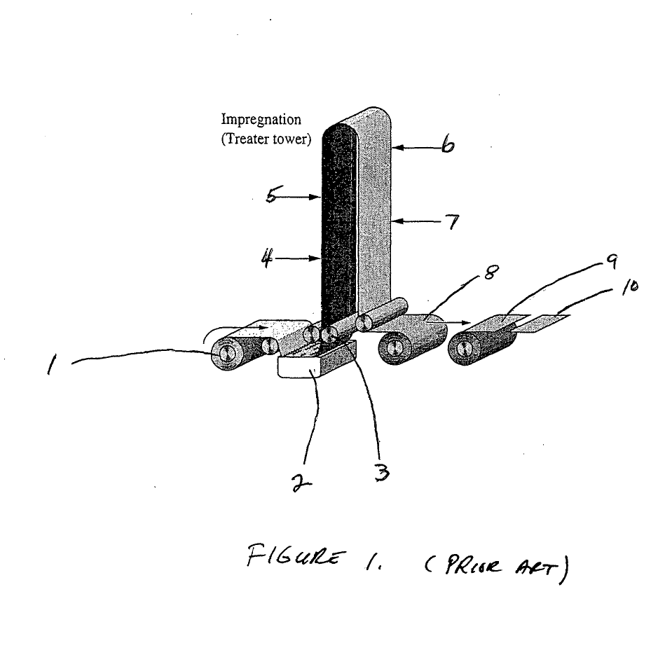

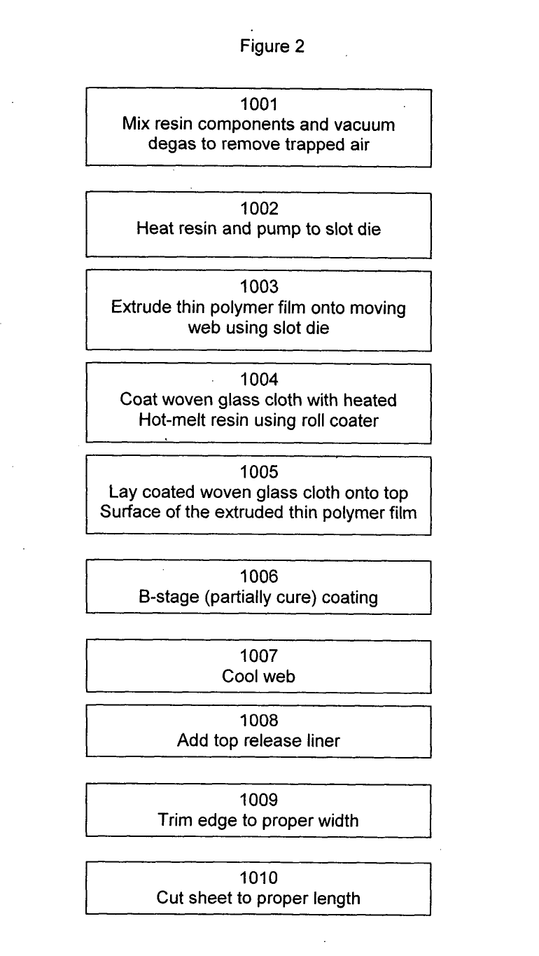

### DETAILED DESCRIPTION

The invention is a method to produce a thermally enhanced film or thermally enhanced fiberglass reinforced prepregs. A prepreg is defined as a partially cured or B-staged resin impregnated into a reinforcement, typically but not limited to a woven glass cloth. Other reinforcements for prepregs include non-woven glass cloth and non-woven organic fibers such as Kevlar.

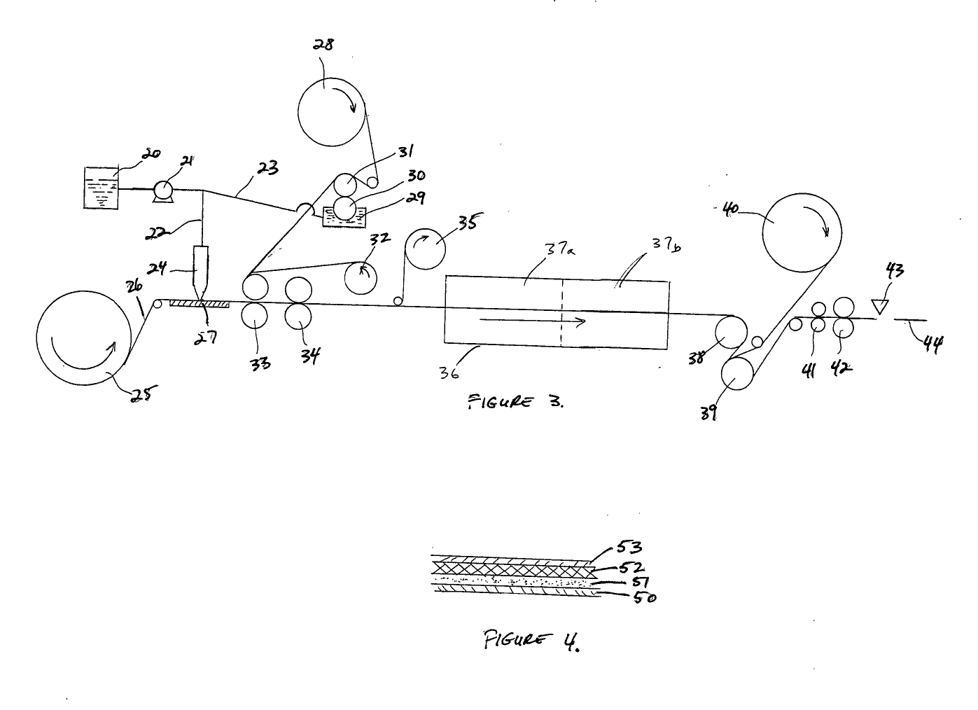

Referring to FIG. 3, the present invention uses a solventless hot melt resin system. The fully mixed resin melt is contained in a temperature controlled reservoir 20. The hot melt it pumped 21 into a temperature controlled transfer hose 22 to a heated slot die extrusion manifold 24. Additionally the hot melt is transferred to a glass cloth coating station through a temperature controlled transfer hose 23.

The process starts with a carrier film unwind station 25. The carrier film 26 can be coated kraft paper or a polymer film. For low temperature applications (process temperatures below 250° F.), a heavyweight polyethylene coated kraft paper will work well. For high temperature applications (T>250° F.) a polyester release film is used. The release film is polyethylene terephthalate (PET). In each case the carrier film is coated with a silicone release agent 26 on the top surface in contact with the resin. The silicone release coating prevents the hot-melt resin coating from adhering to the release liner.

The lower release liner is passed over a temperature controlled table 27. The hot melt resin is applied to the moving release liner by a temperature controlled and precision slot die extrusion manifold 24. The coating thickness is controlled by adjusting the pump speed, the line speed, and the die lip opening.

Woven fiberglass is loaded onto an unwind station 28. The hot melt resin is contained in a temperature controlled reservoir 29. A rubber roller 30 picks up the solventless hot melt in the reservoir and transfers it to a highly polished, temperature controlled resin application roller 31. The fiberglass web is carried over a series of rollers to a fiberglass coating station. As the moving fiberglass web passes over the polished roller 31, the hot melt resin is transferred to the moving fiberglass web. The amount of resin applied to the fiberglass web can be controlled by the speed of the moving rollers 30 and 31. Additionally, the viscosity of the hot melt adhesive and be controlled to aid in the saturation of the moving fiberglass web.

The saturated fiberglass web is placed on a second release liner 32. The purpose of the second release liner is to prevent the coated fiberglass from sticking to the calendaring rolls 33 and 34. The purpose of the calendaring rolls is two fold; to aid in the consolidation of the saturated fiberglass cloth onto the coating of the hot melt resin, and to control the final thickness of the coating and fiberglass cloth.

Prior to entering the B-stage oven 36, the top release liner is removed and collected on an unwind station 35. The release liner is removed to allow better heat transfer during the B-staging and to allow for very small amounts of trapped air to be removed. The moving web then enters into a two-zone B-staging oven. The oven has two temperature controlled zones 37a and 37b. The temperature profile in the two zones is programmed increase the resin temperature as the moving web travels through the B-staging oven. At the B-staging temperature, the latent catalyst and hardener are activated causing a chemical reaction (crosslinking) that causes reactive groups to form covalent bonds and increase the molecular weight. By carefully controlling the temperature, the thermosetting polymer matrix can be partially cured. The degree of B-staging affects the flow during the lamination of printed circuit boards. If the amount of B-staging is too low, the material will flow excessively, causing an inferior final board. If the B-staging is too high, the prepreg will not have adequate flow during lamination, resulting in delamination and poor adhesion of the prepreg to the cores. Therefore, the temperature control during the B-staging step is critical to achieving the desired final product properties.

The moving web emerges from the heated B-staging oven partially cured, but still hot. The chill roll 38 is designed to cool the moving web. A release liner 40 is added to the top surface prior to engaging the second chill roll 39. The wrap angle may be adjusted to control the amount of time the moving web is in contact with the chill rolls. The longer the contact time, the more heat is removed from the moving web.

The edges of the moving web are trimmed using two edge cutters 41. The edge cutters are adjustable to control the final width of the moving web. The web is pulled through the entire apparatus using rubber pull rolls 42. The web speed is controlled by the pull roll speed. Additionally, the pull roll pressure may be adjusted to maintain the coating thickness and prevent slippage of the moving web. After passing through the pull rolls, the sheets are cut to the final size using an in-line shear 43. The sheet dimensions can be controlled using the in-line edge trimmer 41 to cut the width dimension, and the online sheeter 34 to cut the final length dimension. The final product at the end of the line is a multilayer sheet of precise dimensions.

As shown in FIG. 4, each sheet has a bottom release film 50, a coating of solventless resin 51, a layer of saturated fiberglass cloth 52, and a top release liner 53. The two release films 50 and 53 provide a protective cover during storage and handling.

In a second embodiment, the prepreg can be made according to the present invention with copper sheets on each side of the prepreg. The copper carrier is electrodeposited, treated copper foil typically used in printed circuit applications.

The resin is coated on the treated side to enhance adhesion of the coating to the copper foil. The shiny or drum side of the copper foil is opposite the coating. The copper clad, B-staged prepreg can be subsequently laminated using high temperature and pressure to form a fully cured core with good adhesion of the resin to the copper foil.

The fully cured core can be circuitized using standard print and etch methods. A multilayer printed circuit board can be fabricated by sandwiching circuitized cores with additional sheets of prepreg and lamination at high temperature and pressure to form a fully cured multilayer printed circuit board. The prepregs and subsequent laminates made using the current invention have significantly improved thermal conductivities, allowing fabrication of a printed circuit board with improved heat spreading and thermal conductivities.

Thus, specific embodiments and applications of methods for making a prepreg have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A continuous process for producing a reinforced, partially cured thermosetting polymer film comprising the steps of:
using a slot die and melt pumping system to coat a precise thickness of a thermosetting polymer which is free of volatile solvents and is capable of curing without generating liquid or gaseous by-products onto a continuous moving web;
impregnating a woven-glass fabric with a liquid thermosetting polymer as the woven-glass fabric passes over a coating device, wherein said thermosetting polymer is substantially free of volatile solvents and is capable of curing without generating substantial amounts of liquid or gaseous by products;
placing the impregnated woven-glass fabric on the top surface of the thermosetting polymer and consolidating to form a unitary film;
metering the thickness of the unitary film of the woven-glass cloth/polymer coating to the desired thickness using temperature controlled, precision machined and polished metal rollers;
passing the unitary film of the woven-glass cloth/polymer coating through a b-staging oven and partially curing the woven-glass/polymer coating using infrared heating elements;
passing the unitary film of the woven-glass cloth/polymer coating through a series of chilled rolls to cool the web;
placing a fluoropolymer release film on the top surface of the unitary film of the woven-glass cloth/polymer coating wherein the top release liner functions to protect the material from contamination and damage;
passing the unitary film of the woven-glass cloth/polymer coating through a set of edge cutters to trim the moving web to a precise width;
passing the unitary film of the woven-glass cloth/polymer coating through pull rolls wherein the function of said pull rolls is to provide control of the line speed and tension in the moving web; and
passing the unitary film of the woven-glass cloth/polymer coating through a sheeting station wherein an optical sensor detects the proper length of the sheet and activates a sharpened shear to cut the web in the width dimension, thereby completing the operation by producing sheets of B-staged prepreg.

2. The continuous process for producing a reinforced partially cured thermosetting polymer film according to claim 1 wherein the moving web consists of a polyester film coated on one side with a silicone release agent and the silicone release agent is on a first surface that is in contact with the coated polymer film.

3. The continuous process for producing a reinforced partially cured thermosetting polymer film according to claim 1 wherein the moving web consists of a kraft release paper coated on both sides with a polyethylene coating, and a silicone release agent is placed on a first surface that is in contact with the coated polymer film.

4. The continuous process for producing a reinforced partially cured thermosetting polymer film according to claim 1 wherein the moving web consists of a copper foil, and the copper foil has a thickness of at least ½ oz (18 microns or 0.7 mils or 0.0007 inches).

5. The process of claim 4 wherein the copper foil has a thickness less than or equal to 6 oz (152 microns or 8.4 mils or 0.0084 inches).

6. The process of claim 4 wherein the copper foil has a thickness greater than 6 oz (152 microns or 8.4 mils or 0.0084 inches).
